(19) United States
(12) Patent Application Publication
(10) Pub. No.: US 2014/0160170 A1
(43) Pub. Date: Jun. 12, 2014

(54) Provision of an Image Element on a Display Worn by a User

(71) Applicant: NOKIA CORPORATION, Espoo (FI)

(72) Inventor: Kent M. LYONS, Santa Clara, CA (US)

(73) Assignee: Nokia Corporation, Espoo (FI)

(21) Appl. No.: 13/706,470

(22) Filed: Dec. 6, 2012

(51) Int. Cl. G09G 5/38

(52) U.S. Cl. CPC G09G 5/38
USPC 345/676

(57) ABSTRACT

An apparatus, method, and computer readable storage medium that is configured to cause the apparatus at least to cause provision of an image element at a first location on a display worn by a user; and in response to receiving sensor information indicating that the location of the display relative to a head of the user has changed, cause provision of the image element at a second, different, location on the display, wherein the first location and the second location relate to substantially the same position in a field of view of the user is disclosed.

### FIELD OF THE INVENTION

The invention relates generally to worn display. In particular, it relates to a method of provision of an image on a display worn by a user. Some aspects relate to improving the user experience associated with the use of a worn display.

### BACKGROUND OF THE INVENTION

Augmented reality (AR) can refer to the real-time augmenting of elements of a live, direct or indirect, view of a physical, real-world environment by computer-generated images. As a result, the technology functions by enhancing one's current perception of reality. With the help of advanced AR technology, the information about the surrounding real world of the user becomes interactive and digitally manipulable. Artificial information about the environment and its objects can be overlaid on the real world.

By contrast, virtual reality (VR) replaces the real world with a simulated visual experience.

AR and VR can be achieved using display systems worn on one's person such as head-mounted displays or eyeglasses.

Near-to-Eye Display (NED) technology may be used to provide a way for a user to perceive a larger image than the physical device itself. NED may for example use thin plastic Exit Pupil Expander (EPE) light guides with diffractive structures on the surfaces.

### SUMMARY OF THE INVENTION

Generally, embodiments of the invention provide apparatus that may be configured to cause provision of an image element at a first location on a display of apparatus worn by a user; and in response to receiving sensor information indicating that the location of the display relative to a head of the user may have changed, cause provision of the image element at a second, different location on the display, wherein the first location and the second location relate to substantially the same position in a field of view of the user.

A first aspect of the invention provides apparatus comprising at least one processor and at least one memory including computer program code, the at least one memory and the computer program code configured to, with the at least one processor, cause the apparatus at least to:
cause provision of an image element at a first location on a display worn by a user; and
in response to receiving sensor information indicating that the location of the display relative to a head of the user may have changed, cause provision of the image element at a second, different location on the display, wherein the first location and the second location relate to substantially the same position in a field of view of the user.

The at least one memory and the computer program code may be configured, with the at least one processor, to cause the apparatus to respond to determining from the sensor information that the location of the display may have changed vertically relative to the head of the user by causing vertical translation of the image on the display from the first location to the second location.

The at least one memory and the computer program code may be configured, with the at least one processor, to cause the apparatus to respond to determining from the sensor information that the location of the display may have changed horizontally relative to the head of the user by causing horizontal translation of the image on the display from the first location to the second location.

The at least one memory and the computer program code may be configured, with the at least one processor, to cause the apparatus to use the sensor information to determine the location of the display relative to the head of a user.

The sensor information may comprise information indicating a change in location of the display relative to the head of the user. The change in location may comprise a translation relative to a surface of the user.

The sensor information may comprise information indicating the location of the display relative to the head of the user. The display may be translucent.

The at least one memory and the computer program code may be configured, with the at least one processor, to cause the apparatus to cause provision by displaying.

A second aspect of the invention provides a method comprising:
causing, by at least one processor, provision of an image element at a first location on a display of apparatus worn by a user; and
in response to receiving sensor information indicating that the location of the display relative to a head of the user may have changed, causing by the at least one processor provision of the image element at a second, different location on the display, wherein the first location and the second location relate to substantially the same position in a field of view of the user.

Another aspect provides a computer program comprising instructions that when executed by computer apparatus control it to perform the method.

A third aspect of the present invention provides a non-transitory computer-readable storage medium having stored thereon computer-readable code, which, when executed by computing apparatus, causes the computing apparatus to:
cause provision of an image element at a first location on a display of apparatus worn by a user; and
in response to receiving sensor information indicating that the location of the display relative to a head of the user may have changed, cause provision of the image element at a second, different location on the display, wherein the first location and the second location relate to substantially the same position in a field of view of the user.

The computer-readable code when executed may cause the computing apparatus to:
respond to determining from the sensor information that the location of the display may have changed vertically relative to the head of the user by causing vertical translation of the image on the display from the first location to the second location without rotating the image.

The computer-readable code when executed may cause the computing apparatus to:
respond to determining from the sensor information that the location of the display may have changed horizontally relative to the head of the user by causing horizontal translation of the image on the display from the first location to the second location.

The computer-readable code when executed may cause the computing apparatus to use the sensor information to determine the location of the display relative to the head of the user.

The sensor information may comprise information indicating a change in location of the display relative to the head of the user. The change in location may comprise a translation relative to a surface of the user.

The sensor information may comprise information indicating the location of the display relative to the head of the user.

The display may be translucent.

Causing provision may comprise displaying.

A fourth aspect of the invention provides apparatus comprising:
means for causing provision of an image element at a first location on a display of apparatus worn by a user; and
means for, in response to receiving sensor information indicating that the location of the display relative to a head of the user may have changed, causing provision of the image element at a second, different location on the display, wherein the first location and the second location relate to substantially the same position in a field of view of the user.

A fifth aspect of the invention provides apparatus configured to:
cause provision of an image element at a first location on a display of apparatus worn by a user; and
in response to receiving sensor information indicating that the location of the display relative to a head of the user may have changed, cause provision of the image element at a second, different location on the display, wherein the first location and the second location relate to substantially the same position in a field of view of the user.

The apparatus may be configured to respond to determining from the sensor information that the location of the display may have changed vertically relative to the head of the user by causing vertical translation of the image on the display from the first location to the second location without rotating the image.

The apparatus may be configured to respond to determining from the sensor information that the location of the display may have changed horizontally relative to the head of the user by causing horizontal translation of the image on the display from the first location to the second location.

The apparatus may be configured to use the sensor information to determine the location of the display relative to the head of a user.

The sensor information may comprise information indicating a change in location of the display relative to the head of the user. The change in location may comprise a translation relative to a surface of the user.

The sensor information may comprise information indicating the location of the display relative to the head of the user.

The display may be configured to be translucent.

Causing provision may comprise displaying.

### BRIEF DESCRIPTION OF THE DRAWINGS

In the drawings: —

FIG. 1 is a diagram illustrating a head mounted display according to at least one example embodiment;

FIG. 2 is a diagram illustrating an apparatus for providing an image element on a display worn by a user according to at least one example embodiment;

FIGS. 3A and 3B are flow diagrams illustrating sets of operations for providing an image element on a display worn by a user according to at least one example embodiment; and

FIGS. 4, 5 and 6 illustrate examples of providing an image element according to at least one example embodiment.

### DESCRIPTION OF EMBODIMENTS OF THE INVENTION

According to various embodiments of the invention, there is provided an apparatus 100 comprising at least one processor 102 and at least one memory including computer program code.

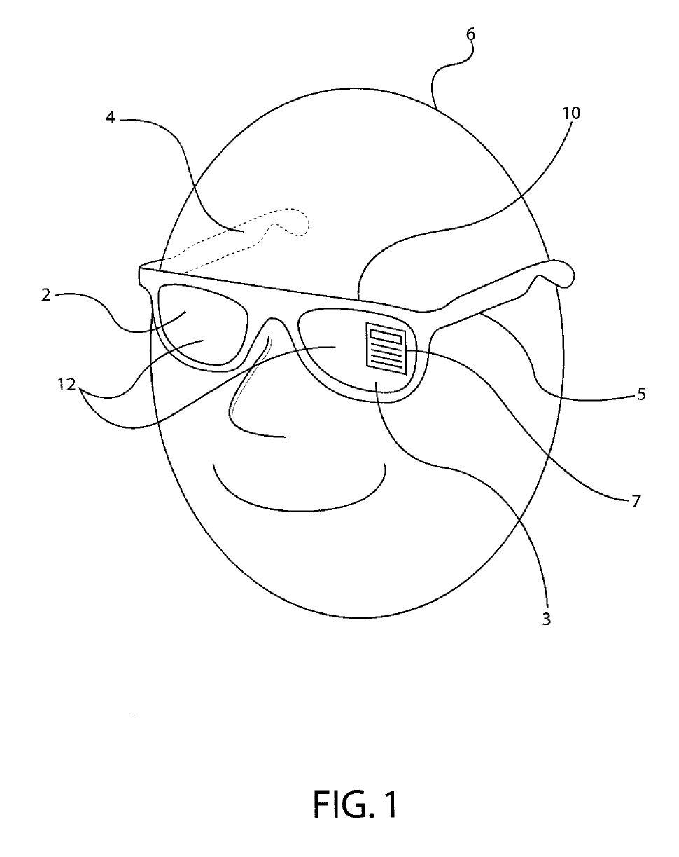

FIG. 1 is a diagram illustrating a head mounted display 10 according to at least one example embodiment. The example of FIG. 1 is merely an example of a head mounted display, and does not limit the scope of the claims. However, a head mounted display may be any apparatus that couples a display to the head of user 6. For example, configuration of the display may vary, coupling between the display and the user may vary, number of displays may vary, and/or the like. The example of FIG. 1 illustrates a head mounted display that is similar to glasses. While glasses are one example of a head mounted display, a head mounted display may be embodied in any of a number of different manners with a variety of form factors. For example, a head mounted display may be similar to a helmet, a visor, and/or the like. For example, the apparatus 100 may be in a form of a helmet worn by a motorcyclist, a pilot or the like.

Head mounted display 10 comprises at least one display 12. In the example of FIG. 1, head mounted display 10 comprises more than one display 12. Information, such as image element 7, may be presented upon display 12.

Head mounted display 10 may comprise a pass through display. A pass through display is a display that provides for presenting information to a user, such that the display allows the user to see objects that are opposite from the head mounted display to the user's eye. For example, a pass through display may be a display where the portion of the display that is capable of presenting information does not necessarily obstruct the ability of the user to see objects on the opposite side of the display. For example, if head mounted display is a pass through display, objects on the opposite side of head mounted display 10 from the user may be part of the field of view of the user.

Head mounted display 10 may comprise a non-pass-through display. A non-pass-through display is a display that provides for presenting information to a user, such that the display obscures objects that are opposite form the head mounted display to the user's eye. For example, the head mounted display may be substantially opaque such that only displayed images are seen by the user in the area of the user's field of view occupied by the display. In such embodiments, objects that are opposite from the head mounted display to the user's eye may be represented in the displayed information such that the representation of the objects is in the field of view of the user. For example, head mounted display 10 may be a virtual reality (VR) head mounted display, such as a VR helmet or VR glasses.

The field of view relates to the view of the eye of the user. For example, if the display is a pass through display, the user's field of view includes image element 7 and any objects that the user can see through display 12. An image element, such as image element 7, displayed by the head mounted display 10 may augment the objects viewed through the head mounted display. For example, an image element may identify or provide supplemental information regarding one or more of the objects viewed through the head mounted display.

In the example of FIG. 1, lens 2 and lens 3 each comprise a display 12. The housing head mounted display 10 may comprise one of more support structures that are configured to couple head mounted display 10 to the user such that display 12 remains in front of the user's eye. For example, head mounted display 10 may be structured such that there is a nose support part that rests upon the nose of the user to support the head mounted display. The nose support part of head mounted display 10 may be configured to fit at the bridge of the user's nose. The nose support part of head mounted display 10 may be in contact with the skin of the user. The housing of head mounted display may comprise a head support part. In the example of FIG. 1, the head support part comprises stem 4 and stem 5, which are configured to rest upon the ears of the user, provide inward tension to the user's head, and/or the like. The head support part may be in contact with the skin of the user.

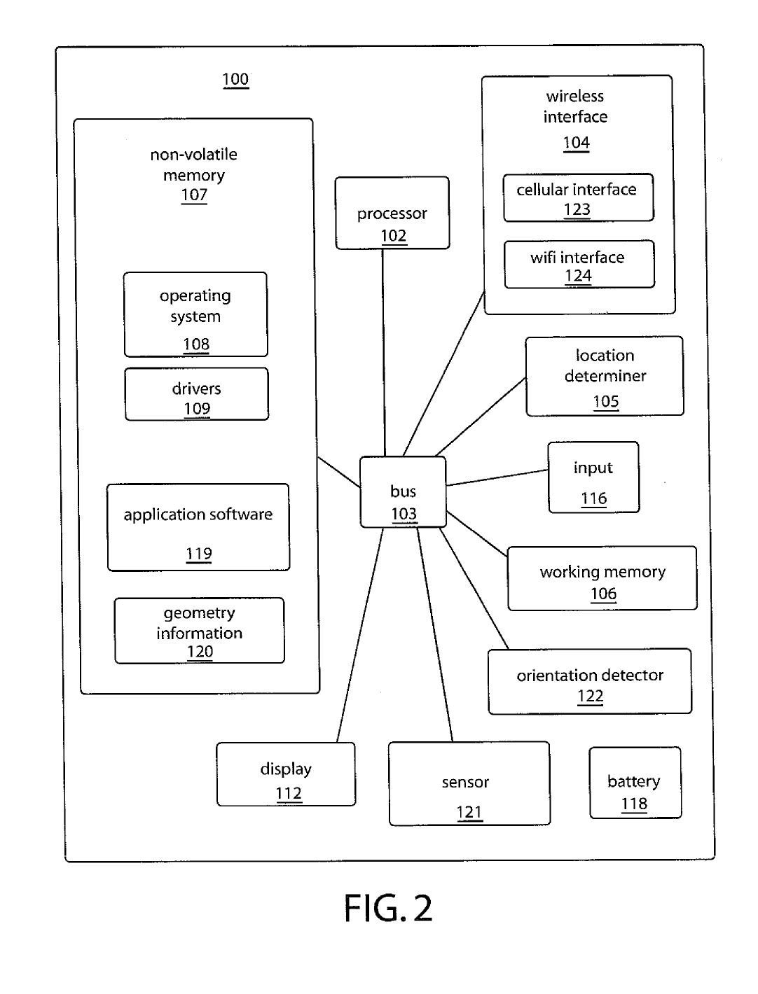

FIG. 2 is a diagram illustrating an apparatus 100 for providing an image element on a display worn by a user according to at least one example embodiment. The example of FIG. 2 is merely an example of an apparatus for providing an image element on a display, and does not limit the scope of the claims. For example, some embodiments may omit one or more elements of FIG. 2 and/or include elements not shown in FIG. 2. Some elements shown in FIG. 2 may be part of apparatus 100 or may be separate from apparatus 100. For example, if apparatus 100 is a head mounted display, display 112 may be part of apparatus 100. In another example, if apparatus 100 is not a head mounted display, display 112 may be separate from apparatus 100.

Apparatus 100 comprises at least one processor 102. Processor 102 may take any suitable form. For instance, it may comprise processing circuitry, including one or more processors each of which may include one or more processing cores. The processing circuitry may be any type of processing circuitry. For example, the processing circuitry may be a programmable processor that interprets computer program instructions and processes data. The processing circuitry may include plural programmable processors. Alternatively, the processing circuitry may be, for example, programmable hardware with embedded firmware. The processing circuitry may be a single integrated circuit or a set of integrated circuits (i.e. a chipset). The processing circuitry may also be a hardwired, application-specific integrated circuit (ASIC).

The apparatus 100 comprises at least one memory, such as non-volatile memory 106 and/or working memory 107. Working memory 106 may be a volatile memory, such as Random Access Memory (RAM), Dynamic Random Access Memory (DRAM), and/or the like. Alternatively, the working memory 106 may be non-volatile. Non-volatile memory 107 may be Read Only Memory (ROM), Programmable Read only memory (PROM), Electronically Erasable Programmable Read Only Memory (EEPROM), flash memory, optical storage, magnetic storage, and/or the like.

The at least one memory, for instance the non-volatile memory 107, may have stored therein computer program code, which may include computer program code for an operating system 108, drivers 109, application software 119, and/or the like. The computer program code may comprise instructions and related data to allow the apparatus 100 to provide a certain function. When processor 102 executes the computer program code, the processor may cause apparatus 100 to perform operations associated with the computer program code.

The computer program code may be stored in the at least one memory, for instance the non-volatile memory 107, and may be executed by the processor 102 using, e.g. the volatile memory 106 for temporary storage of data and/or instructions. The terms ‘memory’ and ‘at least one memory’ when used in this specification may be intended to relate primarily to memory comprising both non-volatile memory and volatile memory unless the context implies otherwise, although the term may also cover one or more volatile memories only, one or more non-volatile memories only, or one or more volatile memories and one or more non-volatile memories.

Processor 102 may execute computer program code comprising the operating system 108. The operating system 108 may comprise computer program code relating to hardware such as a display 112 and inputs 116, as well as the other operations. The operating system 108 may also cause activation of and interact with computer program code modules and computer program code applications stored in the at least one memory.

The computer program code also may comprise drivers 109 to enable processor 102 to perform operations to interface with and control hardware components of apparatus 100. For example, the computer program code may comprise one or multiple ones of the following: a display driver to enable processor 102 to perform operations to perform operations to interface with the display 112, a sensor driver to enable processor 102 to perform operations to interface with one or more sensor 121, an orientation detector driver to enable processor 102 to perform operations to interface with the orientation detector 122, a wireless interface driver to enable processor 102 to perform operations to interface with the wireless interface 104, and/or the like.

The application computer program code 119 may comprise computer program code for one or more applications that can be executed by the apparatus 100. For example, the application computer program code may comprise computer program code for wirelessly updating the other computer program code using the wireless interface 104.

Apparatus 100 is in communication with a display 112. Apparatus 100 may include display 112. Display 112 may be separate from apparatus 100. For example, display 112 may be display 12 of FIG. 1, and apparatus 100 may be separate from head mounted display 10. In such an example, apparatus 100 may be in communication with head mounted display 10 to cause display of image elements on display 12, for example using wireless interface 104.

The apparatus 100 may comprise means for user input, such as input 116, for example hardware keys, a touch input, an audio input such as a microphone and a speech processor, and/or the like. The apparatus 100 may also house a battery 118 to power the apparatus 100.

The processor 102 may control operation of other hardware components of the apparatus 100. The processor 102 and other hardware components may be connected via a system bus 103. Each hardware component may be connected to the system bus either directly or via an interface. However, apparatus 100 may be in communication with other elements by way of a different communication interface. For example, in some embodiments, there may be elements, such as wireless interface 104, inputs 116, etc., in addition to or instead of the bus that the processor uses to communicate with other elements.

The processor 102 may be configured to send and receive signals to and from the other components in order to control operation of the other components. Where in the following the apparatus may be said to do something or provide a function, this may be achieved by the processor 102 controlling the other components of the apparatus 100 according to computer program code comprised in the at least one memory. For example, the processor 102 may control the display of content on a display 112 and may receive signals as a result of user inputs through an interface.

Sensor 121 may be one or more sensors for receiving information regarding the environment of apparatus 100. For example, sensor 121 may comprise an accelerometer, a camera, a motion sensor, and/or the like. One or more sensor 121 may be separate from apparatus 100.

Sensor 121 may provide sensor information to the processor 102 for use by the apparatus 100 in determining changes in the location of a display, such as display 12, relative to the user's head 6. This may involve sensing movement of a surface of the user relative to the sensor arrangement 121. In this context, a surface of the user could be any part of a user, such as an area of the skin, eyes or clothing of the user, for instance an area of the facial skin of the user. Sensor 121 may be configured to detect motion of a surface relative to the sensor at a distance from the sensor. Sensor 121 may detect three-dimensional motion and/or two-dimensional motion. When there is a plurality of sensor 121, apparatus 100 may be configured to determine changes in the location of a display, such as display 112, relative to the user's head in up to six degrees of freedom.

The sensor information may for instance be differential information, indicating a difference is relative locations between the head and the display. It may alternatively be absolute information, from which a comparison with previous information can reveal that there has been movement of the head relative to the user. Here, the sensor information is an indication that the location of the display relative to a head of the user has changed because the information is different to previous information.

In at least one example embodiment, sensor 121 comprises one or more speckle sensor.

In at least one embodiment, sensor 121 comprises one or more illuminated, such as LED-illuminated or laser-illuminated, optical sensor, which may be similar to sensors of an optical mouse.

In at least one embodiment, sensor 121 comprises one or more acoustic sensor. Processor 102 may utilize sensor information comprising acoustic sensor information to determine that the acoustic sensor information corresponds to movement across the surface of the user. Such acoustic sensor information may be used to determine the distance that an object has moved.

In at least one embodiment, sensor 121 comprises one or more camera. The camera may be configured to capture images of an area of a user's head to allow tracking a feature of the user's face. For example, the camera may be located as part of the head mounted display and be directed and controlled to gather digital images of the whole or a part of the face of the user. The camera may be a camera used in gaze tracking. As such, the camera can be used for two functions: gaze tracking and detecting changes in the location of a display, such as display 12, relative to the user's head.

In at least one embodiment, sensor 121 comprises one or more 3D laser scanner. The laser scanner may be configured to scan an area of a user's body and thereby to gather information concerning the shape of the scanned area and the location of the scanned area relative to the scanner.

Different sensors may be located at different positions on a head mounted display. For instance, one or more sensors may be placed in at least one rim of a head mounted display pointed towards the user's face. For example, one sensor may be placed over the nose. Multiple sensors could be used to extract a six degree of freedom change in the location of a display, such as display 12, relative to the user's head. For example, two sensors, (one above each eye, or one in each temple) could provide six degree of freedom sensor information.

In another configuration, optical sensors are placed in the nose bridge of the glasses either directly or connected through a light pipe. Here the sensors detect the movement of the glasses relative to the nose, and in turn this may be used to create the transformation correction.

The orientation detection 122 may be configured to provide sensor information concerning the orientation of a head mounted display. This may be absolute orientation (relative to a reference in the physical world) or it may be orientation relative to an initial orientation. The orientation detection 122 may include an accelerometer for example.

The orientation detection 122 may comprise parts of the sensor 121 and vice versa. Put another way, hardware and/or software may be shared between the orientation detection 122 and the sensor 121.

At least one example embodiment comprises a wireless interface 104. The wireless interface 104 may comprise a cellular interface 123 and a wifi interface 124, a Bluetooth interface, and/or the like. Hardware of the wireless interfaces 104 may comprise suitable antenna and signal processing circuitry.

The wireless interface 104 may comprise hardware for the apparatus 100 to be able to wirelessly communicate data. For example, the cellular interface may comprise hardware which the apparatus 100 can use to communicate data wirelessly via radio according to one of the Global System for Mobiles (GSM), Universal Mobile Telephone System (UMTS) or Long Term Evolution (LTE) standards. Furthermore, the wifi interface may comprise hardware configured to enable to the apparatus 100 to communicate via radio with a wireless local area network (WLAN) using the IEEE 802.11 set of WLAN communication standards. The wireless interfaces of FIG. 1 are shown only by way of example, and embodiments could be implemented on a device comprising other wireless interface technologies or combinations thereof.

The geographic location determiner 105 may be configured to provide information on the geographic location, for instance expressed through latitude and longitude, of apparatus 100. For example, location determination 105 may comprise a GPS (Global Positioning System) receiver. Location determination may comprise a module that receives information about the geographic location of the apparatus 100. For instance, geographic location determiner 105 may comprise a software module that reports base stations and other access points from which signals can be detected at the apparatus 100 to a server on a network, and then receives geographic location information back from that server. Alternatively or additionally, geographic location determiner 105 may include an accelerometer arrangement. In this case, components may be shared between the geographic location determiner 105 and the orientation detector 122.

The apparatus 100 may be discrete and self-contained. Alternatively, the apparatus 100 may be a system comprising two or more discrete components.

In at least one embodiment, geometry information 120 comprises information concerning the relative location of one or more sensors of sensor 121, display 112, and/or aspects of the user's head may be considered by the computer program code. In at least one embodiment, geometry information 120 may be stored in the memory. The geometry information 120 may comprise a mathematical model representing aspects of the user's head 6 and/or information defining geometric relationships between aspects of a user's head 6 and the sensor arrangement 121 and/or a head mounted display, such as display 12. For example, a model of the user's head may comprise a mathematical representation of one or more reference points associated with anatomy of a user's head. For instance, a model of the user's head may comprise information indicating mathematically the location of the user's eyes. This may include information on the location of aspects of the user's head including the user's eyes 134 relative to the head mounted display, one or more sensors of sensor 121, and/or the like. Geometry information relating location of the sensors of sensor 121 to the display 112 may for example be predetermined based on the manufactured dimensions of the head mounted display. For instance, the design and/or manufacturing of the head mounted display may be such that geometry information may be predictable. In some embodiments, geometry information 120 may be adjusted, for example via calibration.

In at least one embodiment that includes sensor 121 comprising one or more speckle sensors, the geometry information 120 may be configured to contain information regarding the relative location of one or more speckle sensor, the display, and a mathematical model of aspects of the user's head comprising the areas targeted by one or more speckle sensor. The apparatus 100 here use the geometry information to resolve from the combined information of each of the plurality of speckle sensors the change in the location of the display relative to the aspects of the head addressed by the geometry information.

In at least one embodiment, sensor 121 may comprise a camera configured to capture digital images of the user's face for use by the glasses in tracking facial features of the user relative to the camera. The geometry information 120 may comprise information regarding the relative location of the camera, the display and one or more facial features of the user. The apparatus 100 may process images provided by the camera using feature extraction/recognition techniques to determine the location of the one or more facial features the user relative to the camera, and then compare the determined location of the one or more facial features with the facial feature information of the geometry information 120 to determine if and/or how the location of the one or more facial features had changed relative to the camera. Using the geometry information relating the camera to the display 112, the processor 102 of the apparatus 100 can determine how the location of the display 112 had changed relative to the one or more facial features of the user.

As the location of the head mounted display changes, the locations of the image elements are changed to reduce movement of the image elements in the field of view of the user attributable to the movement of the head mounted display in relation to the head of the user.

In these embodiments, the at least one memory and the computer program code are configured to, with the at least one processor 102, cause the apparatus 100 to cause provision of an image element at a first location on a display, such as display 112. For instance, the apparatus 100 may cause display the image element at the first location on the display 112, or it may send signals to cause another apparatus displaying the image element at the first location on the display 112. The image element may be any part or combination of any information visually presented to a user, such as an icon, text, a graphic, an animation, a 3D illustration for instance, and/or the like.

Provision of the image element may comprise display (for instance through projection), in either case using any suitable technology, for instance. Using sensor information may comprise detecting relative movement between the apparatus and the user's head. Using sensor information may comprise determining a relative position of the head mounted display and comparing the determined position to a previously determined position of the head mounted display. Apparatus 100 may change the location of display of the image element such that the image element is located at substantially the same position in the user's field of view before and after the location of the display relative to the head of the user has changed. For example, apparatus 100 may cause display of an image element at a first location on the display, and cause display of the image element at a second location on the display in response to change in the location of the display relative to the head of the user. The first location and the second location may relate to substantially the same position in a field of view of the user as closely as the configuration of the apparatus 100 may permit. Ideally, the first location and the second location relate to exactly the same position in a field of view of the user. However, limitations in accuracy of sensing the relative locations of the head and the display may mean that the first location and the second location do not relate to exactly the same position in the field of view of the user. Also, the resolution of the display 112 may be such that it is not possible for the first location and the second location to relate to exactly the same position in the field of view of the user. Similarly, it may be desirable to preserve processing resources of the processor 102, such that it is not possible or practical for the first location and the second location to relate to exactly the same position in a field of view of the user at all times. This may be particularly true in the case of the head mounted display moving relative to the head of the user relatively often or relatively quickly. Therefore, even though such circumstances may result in the first location and the second location having different locations in the field of view of the user, these deviations are insubstantial such that the first location and the second location relate to substantially the same position in a field of view of the user.

In at least one embodiment, the at least one memory and the computer program code may be configured to, with the at least one processor 102, cause the apparatus 100 to respond to determining from the sensor information that the location of the display has changed vertically relative to the head of the user by causing vertical translation of the image on the display from the first location to the second location without rotating the image. For instance, the apparatus may respond to detecting that the display has moved down relative to the user's head by causing translation of the image on the display upwards. The apparatus may respond to detecting that the display has moved up relative to the user's head by causing translation of the image on the display downwards.

In at least one embodiment, the at least one memory and the computer program code may be configured to, with the at least one processor 102, cause the apparatus 100 to respond to determining from the sensor information that the location of the display has changed horizontally relative to the head of the user by causing horizontal translation of the image on the display from the first location to the second location.

In at least one embodiment, the at least one memory and the computer program code may be configured to, with the at least one processor 102, cause the apparatus 100 to use the sensor information to determine the location of the display relative to the head of a user. Determining the location of the head relative to the display from the sensor information may involve for example identifying a feature of the head and determining its location relative to the display, or tracking one or more features to determine the location of the head relative to the display. Determining the location of the head from the sensor information may involve for example determining a location of the head relative to one or more sensors and using that information to calculate the location relative to the display.

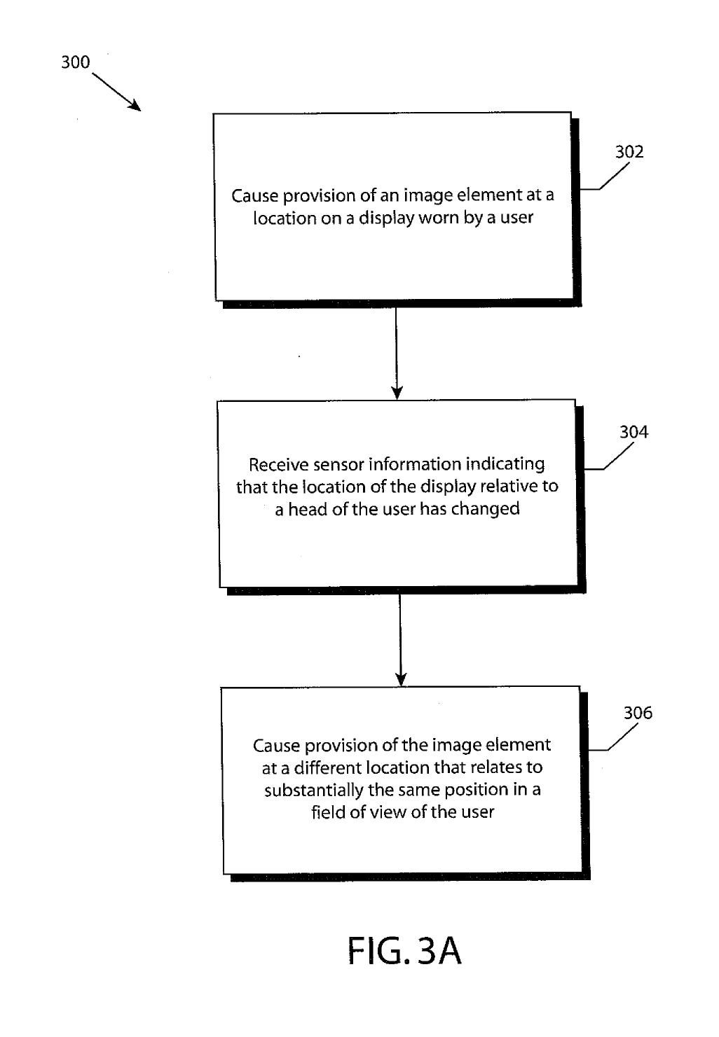

FIG. 3A is a flow diagram illustrating a set of operations 300 for providing an image element on a display worn by a user according to at least one example embodiment. An apparatus, for example apparatus 100 or a portion thereof, may utilize the set of operations 300. The apparatus may comprise means, including, for example processor 102, for performing the operations of FIG. 3A. In an example embodiment, an apparatus, for example apparatus 100, is transformed by having memory, for example memory 107, comprising computer program code configured to, working with a processor, for example processor 102, cause the apparatus to perform set of operations 300.

At block 302, the apparatus causes provision of an image element at a location on a display worn by a user. For purposes of term differentiation, the location of the image element on the display described with regards to block 302 may be referred to as a first location. However, it should be understood that the term “first” is used purely for purposes of term differentiation and does not limit the claims in any way. For example, the term “first” does not denote any ordering or chronology. The location of an image element may be determined in any suitable way. The first location for the image element may be for instance calculated having regard to the location (x, y, z) and orientation of the apparatus 100, and information relating to objects and other elements in the scene. The information relating to objects and other elements in the scene may be pre-stored in the memory, or it may be received through the wireless interface 104. The initial location may be determined so as to align the image element with a certain object and/or other point in the user's field of view.

The apparatus 100 may be configured to provide an AR display in any suitable way. For instance, the apparatus 100 may identify an object in the field of view of the user, and display an image element containing additional information relating to the object. In this manner, the image element may appear to the user to be superimposed onto the corresponding object. For example, the field of view of the user may include objects such as a street and buildings. In such an example, image elements may be graphical/textual information relating to the buildings and the street. For example, the first location of the image element may be based on geographic location information, for example from geographic location determiner 105, orientation information, for example from orientation detector 122, and/or the like. Causing display of the image element comprises performing an operation that results in presentation of a representation of the image element to the user. For example, the apparatus may display the image element on a display comprised by the apparatus, send information to a separate apparatus that comprises the display so that the separate apparatus displays the image element, and/or the like.

At block 304, the apparatus receives sensor information, for example from sensor 121, indicating that the location of the display relative to a head of the user has changed. In at least one example embodiment, the sensor information is received by way of receiving sensor information from within the apparatus. In at least one embodiment, the sensor information is received by way of communication with a separate apparatus. The received sensor information may be used to determine what, if any, change there may have been in the display location relative to the head of the user. In circumstances where there has been a change in the display location, the sensor information may indicate direction of movement, a distance of movement, and/or the like.

At block 306, the apparatus causes provision of the image element at a different location that relates to substantially the same position in a field of view of the user. For purposes of term differentiation, the location of the image element on the display described with regards to block 306 may be referred to as a second location. However, it should be understood that the term “second” is used purely for purposes of term differentiation and does not limit the claims in any way. For example, the term “second” does not denote any ordering or chronology. The second location may be determined such that the image element is at substantially the same location in the field of view of the user. The second location may be based, at least in part, on the sensor information. In at least one example embodiment, the second location is based on the same criteria as the first location, with further consideration of the sensor information indicating that the location of the display relative to the head of the user has changed. Causing display of the image element at the second location may comprise precluding display of the image element at the first location.

In at least one embodiment, the apparatus causes provision of the image at a different location by adjusting a physical characteristic of the display, such as tilt, focus, and or the like. For example, the display may comprise mechanically adjustable optical properties. In such an example, the optical properties may be adjusted to cause provision of the image element at the different location.

It should be noted that the second location may be determined independently of any change in orientation. Therefore, the second location may be determined absent any orientation change of the image element. For example, if the display rotates, the rotation of the image element may be determined independently of the location of the image element. In another example, orientation of the image element may be ignored.

FIG. 3B is a flow diagram illustrating a set of operations 350 for providing an image element on a display worn by a user according to at least one example embodiment. An apparatus, for example apparatus 100 or a portion thereof, may utilize the set of operations 350. The apparatus may comprise means, including, for example processor 102, for performing the operations of FIG. 3B. In an example embodiment, an apparatus, for example apparatus 100, is transformed by having memory, for example memory 107, comprising computer program code configured to, working with a processor, for example processor 102, cause the apparatus to perform set of operations 350.

At block 352, the apparatus causes provision of an image element at a location on a display worn by a user. Block 352 may be similar as described with reference to block 302 of FIG. 3A.

At block 354, the apparatus receives sensor information, for example from sensor 121, indicating that the location of the display relative to a head of the user has changed. Block 354 may be similar as described with reference to block 304 of FIG. 3A.

At block 356, the apparatus determines location of the display relative to the head of the user. Determination of the location of the display relative to the head of the user may be based, at least in part, on the sensor information. Determination of the location of the location of the display relative to the head of the user may be similar as described regarding sensor information as described previously.

At block 358, the apparatus determines whether the location of the display has changed vertically relative to the head of the user. If the apparatus may determine the second location based, at least in part, on vertical translation of the image element. Therefore, at block 360, the apparatus causes vertical translation of the image element on the display. The vertical translation may be based on adjusting the vertical location of the first location on the display so that the second location is at substantially the same location in the field of view of the user, after movement of the display relative to the head of the user. Causing adjustment may comprise causing display of the image element at the second location. If, at block 358, the apparatus determines that location of the display relative to the head of the user has not changed vertically, operation proceeds to block 362.

At block 362, the apparatus determines whether the location of the display has changed horizontally relative to the head of the user. If the apparatus may determine the second location based, at least in part, on horizontal translation of the image element. Therefore, at block 364, the apparatus causes horizontal translation of the image element on the display. Causing adjustment may comprise causing display of the image element at the second location. The horizontal translation may be based on adjusting the horizontal location of the first location on the display so that the second location is at substantially the same location in the field of view of the user, after movement of the display relative to the head of the user.

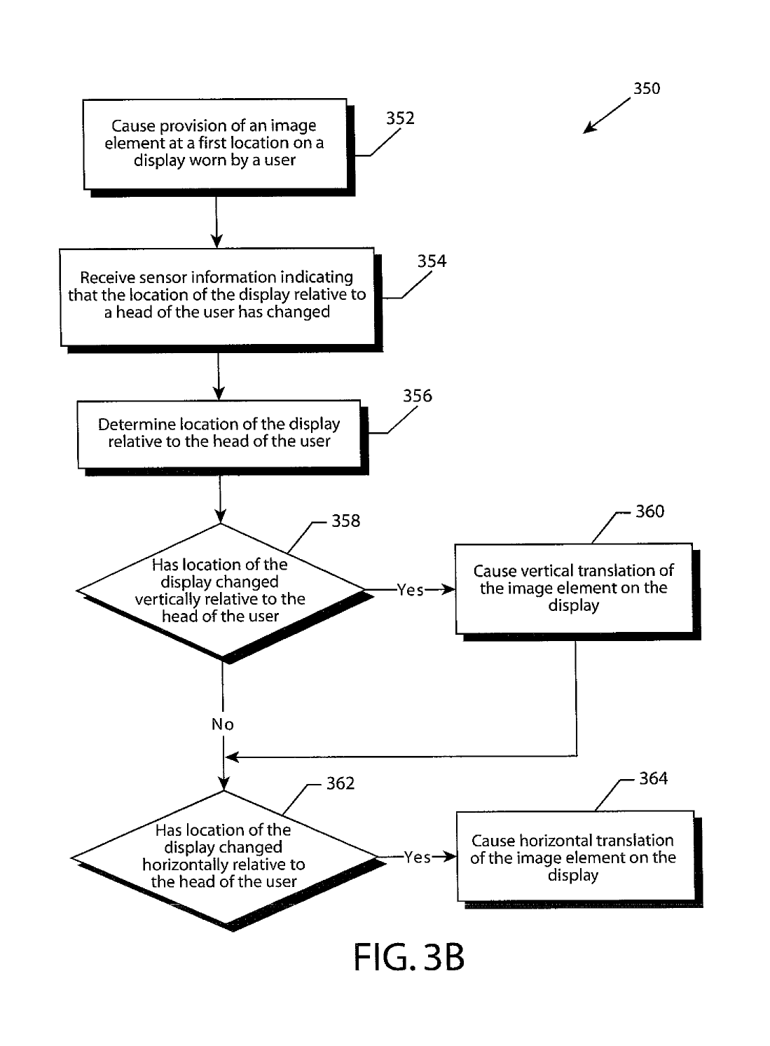

FIGS. 4, 5 and 6 illustrate examples of providing an image element according to at least one example embodiment. Even though FIGS. 4-6 illustrate different movement of a display in relation to the head of a user, these movements may be combined such that the apparatus may determine a movement comprising one or more movements, such as a translation, change in distance, change in angle, and/or the like. Detecting movement of the head mounted display relative to the user's head may allow for location of image elements to be altered such that the user sees the elements at substantially the same location in the user's field of view. An effect of this may be that the experience of the user may avoid being negatively affected by movement of the head mounted display on the user. For instance, whereas the head mounted display slipping down a user's nose might otherwise cause the display of image elements not to coincide with objects in the user's field of view, the apparatus may determine movement of the head mounted display in relation to the head of the user so that display of image elements may be adapted such that they substantially coincide with the objects in the field of view of the user, before and after movement of the display relative to the head of the user.

FIG. 4 shows a display as seen in the field of view of a user, at a first instance 125a and a second, later instance 126a in time. At the first instance 125a the display is at a first location relative to the head of the user. At the second instance 125a the display is at a second, different location relative to the head of the user. Between the first and second instances, the location of the display relative to the user's head has changed, as may occur through the user walking, jogging, bumping the display, etc. As seen by the user, the second location may be vertically and/or horizontally displaced from the first location. In some circumstances, no change in the orientation of the display may have occurred. In both instances the display may be orientated such that the plane of the display may be substantially perpendicular to the line of sight of the user. The plane of the display in both instances may lie at approximately the same distance from the head of the user. In other words, in the time between the two instances the location of the display relative to the head of the user may have translated laterally by a vector A.

At both instances, an image element 127 may be provided on the display. The image element may be provided on the display at a first location 129a at the first instance 125a. The image element may be provided on the display at a second, different location 130a at the second instance 126a.

By using sensor information, the apparatus may determine the change in the location of the display relative to the user's head. The sensor information may be then used to cause the image element 127 to be provided at the second location 130a, such that the first location and the second location relate to substantially the same position in a field of view of the user. Put another way, the first location 129a and the second location 130a relate to substantially the same position in a field of view of the user. A dashed illustration 131a of the image element may be depicted as it would appear if, during the second instance 126a, it were still provided on the display at the first location 129a.

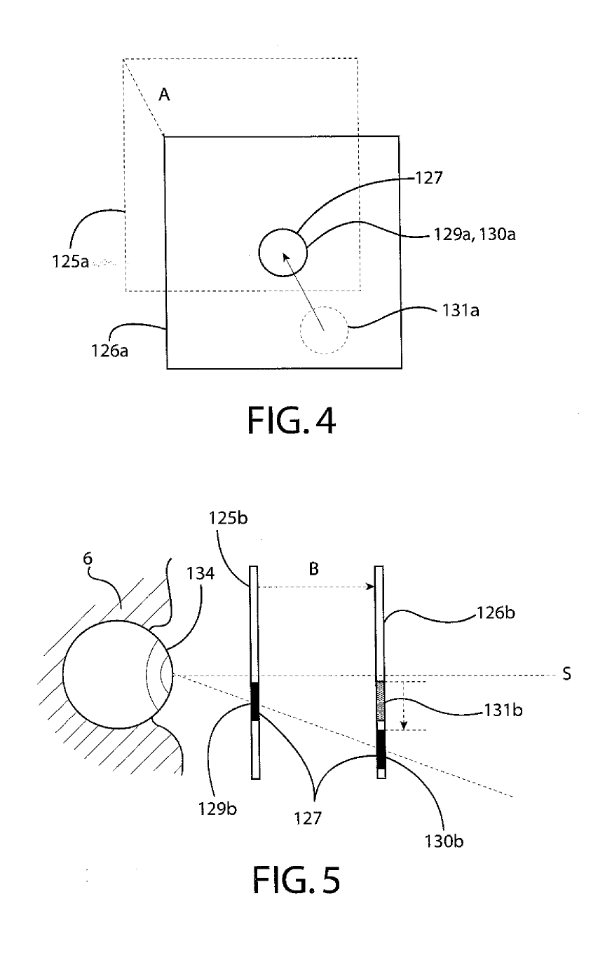

With reference to FIG. 5, a side view cross-section of a head 6 of a user including a user's eye 134 and a display, for instance display 112, is shown. The display may be shown at a first instance 125b and a second, later instance 126b in time. At the first instance 125b the display is at a first location relative to the head 6 of the user. At the second instance 125b the display is at a second, different location relative to the head of the user. In both instances the display 112 may be orientated such that the plane of the display is substantially perpendicular to the line of sight S of the user. The difference between the first location and the second location may comprise a movement of the display away from the user's head only, without any change in the orientation of the display. In other words, in the time between the two instances 125b, 126b the location of the display relative to the head 6 of the user may have translated away from the head of the user by a distance B.

At both instances, an image element 127 may be provided on the display. The image element may be provided on the display at a first location 129b during the first instance 125b. The image element may be provided on the display at a second, different location 130b during the second instance 126b. Following the first instance 125b, by using sensor information, the apparatus may determine the change in the display location relative to the user's head 6. The apparatus may determine change in the display location relative to the user's eye 134. This determined change in location may be used to cause the image element to be provided at the second location 130b, such that, in both instances 125b, 126b, the image element 127 remains at the same location in the user's field of view. A dashed illustration 131b of the image element may be depicted as it would appear if, during the second instance 126b, it were still provided on the display at the first location 129b.

Tilting of the display forwards or sideways (which can occur in some circumstances) may also be accommodated. In the case of the apparatus 100 being a helmet or such like, other types of movement between the display of the worn apparatus 100 and the user's head 6 may occur, and be corrected by embodiments of the invention. Such types of movement include horizontal or vertical translation relative to a user's face, translation towards or away from the head, and tilting. Tilting may be in up to three ways, namely roll, pitch and yaw. Movement may occur in two or more directions and/or rotation axes simultaneously.

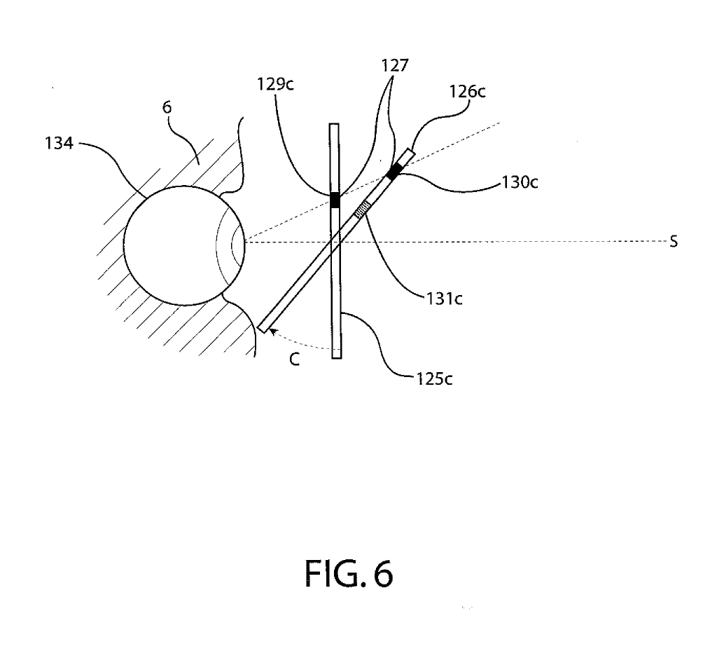

With reference to FIG. 6, a side view cross-section of a head 6 of a user including a user's eye 134 and a display is shown. The display is shown at a first instance 125c and a second, later instance 126c in time. At the first instance 125c the display is at a first location relative to the head of the user. At the second instance 126c the display is at a second, different location relative to the head of the user. In the first instances the display may be orientated such that the plane of the display may be substantially perpendicular to the line of sight S of the user. The difference between the first location and the second location may comprise a tilting of the plane of the display by an angle C away from being perpendicular to the line of sight of the user and without experiencing any other changes in its orientation.

At both instances 125c, 126c, an image element 127 may be provided on the display. The image element 127 may be provided on the display at a first location 129c during the first instance 125c. The image element may be provided on the display at a second, different location 130c during the second instance 126c. Following the first instance, by using sensor information, the apparatus may determine the change in the display location relative to the user's head 6. The apparatus may determine the change in the display location relative to the user's eye 134. This determined change in location may be used to cause the image element to be provided at the second location 130c, such that, in both instances 125c, 126c, the image element remains at the same location in the user's field of view. A dashed illustration 131c of the image element may be depicted as it would appear if, during the second instance 126c, it were still provided on the display at the first location 129c.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any tangible media or means that can contain, or store the instructions for use by or in connection with an instruction execution system, apparatus, or device, such as a computer, with one example of a computer described and depicted in FIG. 6. The tangible media may be non-transient. A computer-readable medium may comprise a computer-readable storage medium that may be any tangible media or means that can contain or store the instructions for use by or in connection with an instruction execution system, apparatus, or device, such as a computer.

If desired, the different functions discussed herein may be performed in a different order and/or concurrently with each other. For example, block 358 of FIG. 3B may be performed after block 362. Furthermore, if desired, one or more of the above-described functions may be optional or may be combined. For example, blocks 356, 358, 360, 362, and 364 of FIG. 3B may be optional and/or combined with block 510.

The disclosure of the present application should be understood to include any novel features or any novel combination of features either explicitly or implicitly disclosed herein or any generalisation thereof and during the prosecution of the present application or of any application derived therefrom, new claims may be formulated to cover any such features or combinations of such features.

1. An apparatus comprising at least one processor and at least one memory including computer program code, the at least one memory and the computer program code configured to, with the at least one processor, cause the apparatus at least to:
cause provision of an image element at a first location on a display worn by a user; and
in response to receiving sensor information indicating that the location of the display relative to a head of the user has changed, cause provision of the image element at a second, different, location on the display, wherein the first location and the second location relate to substantially the same position in a field of view of the user.

2. The apparatus of claim 1, wherein the at least one memory and the computer program code are configured, with the at least one processor, to cause the apparatus to respond to determining from the sensor information that the location of the display has changed vertically relative to the head of the user by causing vertical translation of the image element on the display from the first location to the second.

3. The apparatus of claim 1, wherein the at least one memory and the computer program code are configured, with the at least one processor, to cause the apparatus to respond to determining from the sensor information that the location of the display has changed horizontally relative to the head of the user by causing horizontal translation of the image on the display from the first location to the second location.

4. The apparatus of claim 1, wherein the at least one memory and the computer program code are configured, with the at least one processor, to cause the apparatus to use the sensor information to determine the location of the display relative to the head of a user.

5. The apparatus of claim 1, wherein the sensor information comprises information indicating a change in location of the display relative to the head of the user.

6. The apparatus of claim 5, wherein the change in location comprises a translation relative to a surface of the user.

7. The apparatus of claim 1, wherein the sensor information comprises information indicating the location of the display relative to the head of the user.

8. The apparatus of claim 1, wherein the display is translucent.

9. The apparatus of claim 1, wherein first location and the second location are in substantially the same location with respect to an object in the field of view of the user.

10. A method comprising:
causing, by at least one processor, provision of an image element at a first location on a display of apparatus worn by a user; and
in response to receiving sensor information indicating that the location of the display relative to a head of the user has changed, causing by the at least one processor provision of the image element at a second, different location on the display, wherein the first location and the second location relate to substantially the same position in a field of view of the user.

11. A non-transitory computer-readable storage medium having stored thereon computer-readable code, which, when executed by computing apparatus, causes the computing apparatus to:
cause provision of an image element at a first location on a display of apparatus worn by a user; and
in response to receiving sensor information indicating that the location of the display relative to a head of the user has changed, cause provision of the image element at a second, different location on the display, wherein the first location and the second location relate to substantially the same position in a field of view of the user.

12. The non-transitory computer-readable storage medium of claim 11, having stored thereon computer-readable code, which, when executed by computing apparatus, causes the computing apparatus to:
respond to determining from the sensor information that the location of the display has changed vertically relative to the head of the user by causing vertical translation of the image on the display from the first location to the second location without rotating the image.

13. The non-transitory computer-readable storage medium of claim 11, having stored thereon computer-readable code, which, when executed by computing apparatus, causes the computing apparatus to:
respond to determining from the sensor information that the location of the display has changed horizontally relative to the head of the user by causing horizontal translation of the image on the display from the first location to the second location.

14. The non-transitory computer-readable storage medium of claim 11, having stored thereon computer-readable code, which, when executed by computing apparatus, causes the computing apparatus to use the sensor information to determine the location of the display relative to the head of the user.

15. The non-transitory computer-readable storage medium of claim 11, wherein the sensor information comprises information indicating a change in location of the display relative to the head of the user.

16. The non-transitory computer-readable storage medium of claim 15, wherein the change in location comprises a translation relative to a surface of the user.

17. The non-transitory computer-readable storage medium of claim 11, wherein the sensor information comprises information indicating the location of the display relative to the head of the user.

18. The non-transitory computer-readable storage medium of claim 11, wherein the display is translucent.

19. The non-transitory computer-readable storage medium of claim 11, wherein first location and the second location are in substantially the same location with respect to an object in the field of view of the user.

20. An apparatus comprising: means for causing provision of an image element at a first location on a display of apparatus worn by a user; and
means for, in response to receiving sensor information indicating that the location of the display relative to a head of the user has changed, causing provision of the image element at a second, different location on the display, wherein the first location and the second location relate to substantially the same position in a field of view of the user.

21-30. (canceled)
